(19) United States
(12) Patent Application Publication
(10) Pub. No.: US 2024/0322659 A1
(43) Pub. Date: Sep. 26, 2024

(54) METHOD FOR MANUFACTURING STATOR CORE AND APPARATUS FOR MANUFACTURING STATOR CORE

(71) Applicant: TOYOTA BOSHOKU KABUSHIKI KAISHA, Aichi-ken (JP)

(72) Inventor: Yuka NAKAI, Kariya-shi (JP)

(73) Assignee: TOYOTA BOSHOKU KABUSHIKI KAISHA, Aichi-ken (JP)

(21) Appl. No.: 18/600,892

(22) Filed: Mar. 11, 2024

(30) Foreign Application Priority Data
Mar. 23, 2023 (JP) 2023-046549

(51) Int. Cl. H02K 15/02; B21D 28/26

(52) U.S. Cl. CPC H02K 15/024; B21D 28/26

(57) ABSTRACT

A method for manufacturing a stator core includes punching out a center hole scrap from a workpiece, thereby forming a first through-hole that forms a center hole, and punching out multiple slot scraps from the workpiece in which the first through-hole has been formed, thereby forming multiple second through-holes that respectively form the multiple slots. The punching out the center hole scrap from the workpiece includes a deformation process. The deformation process is performed only on at least one of inner surfaces of support portions. The inner surfaces of the support portions are parts of the inner surface of the die hole. The support portions are parts of the die that support portions of the workpiece in which the second through-holes are to be formed.

### BACKGROUND

### 1. Field

The present disclosure relates to a method for manufacturing a stator core and an apparatus for manufacturing a stator core.

### 2. Description of Related Art

A stator core used in a rotating electric machine includes an annular yoke having a center hole and teeth extending radially inward from the yoke. A slot that is continuous with the center hole is formed between adjacent teeth.

Japanese Laid-Open Patent Publication No. 2021-125953 discloses a method for manufacturing a stator core by stacking core pieces punched out from a workpiece using a punch and a die. In this method, first, multiple slot scraps are punched out from a workpiece to form multiple slot spaces that forms slots. Then, a center hole scrap is punched out from the workpiece such that a through-hole forming a center hole is continuous with the slot spaces. After core pieces are punched out from the workpiece, the iron stator cores are stacked to manufacture a stator core.

In the method disclosed in the publication, the center hole scrap is punched out from the workpiece after the slot scraps are punched out from a workpiece. That is, when the center hole scrap is punched out, the slot spaces have already been formed in the workpiece. Thus, the parts of the outer circumferential edge of the center hole scrap that face the respective slot spaces are not in contact with the interior of the die. In this case, since the area of contact between the center hole scrap and the die is reduced as compared with a case in which the entire outer circumferential edge of the center hole scrap is in contact with the interior of the die, the center hole scrap is unlikely to be held inside the die. This may cause the center hole scrap to rise and separate from the interior of the die as the punch rises, that is, so-called scrap rising may occur. The main cause of scrap rising includes, for example, burrs formed in the center hole scrap biting into the punch and the center hole scrap adhering to the punch due to machining oil or magnetic force of the workpiece. Since the manufacture of the stator core is not smoothly performed when scrap rising occurs, it is desired to suppress the occurrence of scrap rising.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a stator core is provided. The stator core includes a center hole and multiple slots. The slots are continuous with the center hole and spaced apart from each other in a circumferential direction of the center hole. The stator core is formed by stacking multiple core pieces punched out from a workpiece. The method includes punching out a center hole scrap from the workpiece through cooperation of a punch and a die that includes a die hole in which the punch moves back and forth, thereby forming a first through-hole that forms the center hole. The method also includes punching out multiple slot scraps from the workpiece in which the first through-hole has been formed, thereby forming multiple second through-holes that respectively form the multiple slots. The punching out the center hole scrap from the workpiece includes a deformation process that plastically deforms the center hole scrap by sliding the center hole scrap on a scrap-rising suppressing portion provided on an inner surface of the die hole, thereby increasing a frictional force between the inner surface of the die hole and the center hole scrap. The deformation process is performed only on at least one of inner surfaces of support portions, the inner surfaces of the support portions being parts of the inner surface of the die hole, and the support portions being parts of the die that support portions of the workpiece in which the second through-holes are to be formed.

In another general aspect, an apparatus for manufacturing a stator core is provided. The stator core includes a center hole and multiple slots. The slots are continuous with the center hole and spaced apart from each other in a circumferential direction of the center hole. The stator core is formed by stacking multiple core pieces punched out from a workpiece. The apparatus includes a first punching station and a second punching station.

The first punching station includes a punch and a die that includes a die hole in which the punch moves back and forth. The first punch-out station is configured to punch out a center hole scrap from the workpiece through cooperation of the punch and the die, thereby forming a first through-hole that forms the center hole. The second punching station is configured to punch out multiple slot scraps from the workpiece in which the first through-hole has been formed, thereby forming multiple second through-holes that respectively form the multiple slots. A scrap-rising suppressing portion is provided on an inner surface of the die hole. The scrap-rising suppressing portion plastically deforms the center hole scrap by sliding the center hole scrap on the scrap-rising suppressing portion, thereby increasing a frictional force between the inner surface of the die hole and the center hole scrap. The die includes support portions that are configured to support portions of the workpiece in which the second through-holes are to be formed. The support portions each have an inner surface that is a part of the inner surface of the die hole. The scrap-rising suppressing portion is provided only on the inner surface of at least one of the support portions.

Other features and aspects will be apparent from the following detailed description, the drawings, and the claims.

### BRIEF DESCRIPTION OF THE DRAWINGS

FIG. 1 is a plan view schematically showing the structure of a rotating electric machine including a stator core according to an embodiment.

FIG. 2 is a cross-sectional view schematically showing the structure of a pressing device according to the embodiment shown in FIG. 1.

FIG. 3 is a plan view showing a workpiece machined by the pressing device shown in FIG. 2.

FIG. 4 is a plan view showing a first die shown in FIG. 2.

FIG. 5 is a perspective view showing the first die shown in FIG. 2.

FIG. 6 is a plan view showing a center hole scrap that includes protrusions.

FIG. 7 is a cross-sectional view of a first die according to a first modification.

FIG. 8 is a front view schematically showing a first die according to a second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art.

Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

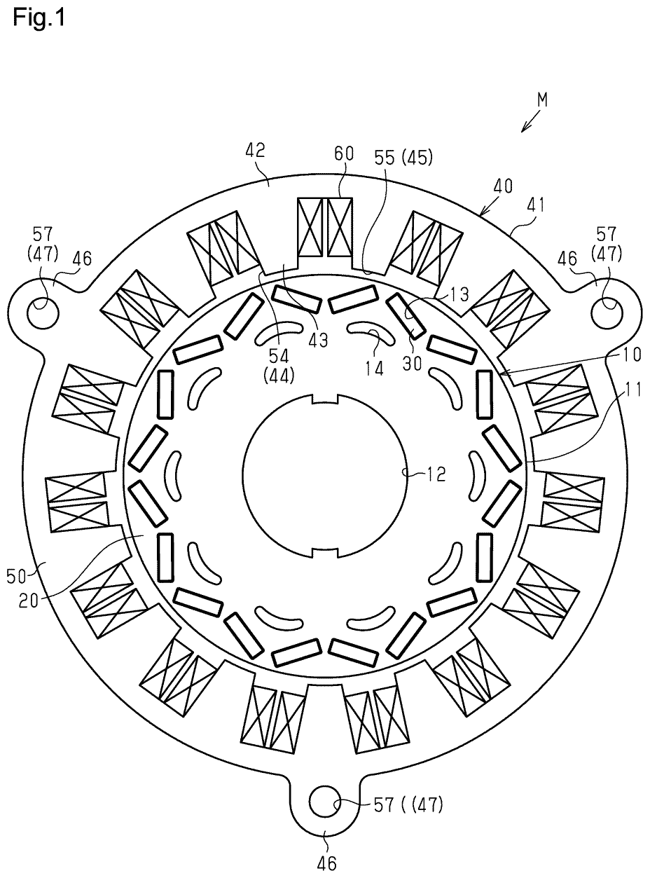

A method for manufacturing a stator core and an apparatus for manufacturing a stator core according to an embodiment will now be described with reference to FIGS. 1 to 6.

### Rotating Electric Machine M

As shown in FIG. 1, a rotating electric machine M includes a rotor 10 and a stator 40, which surrounds the rotor 10. The rotor 10 and the stator 40 each have a substantially cylindrical shape. The rotor 10 is configured to be rotatable inside the stator 40.

### Rotor 10

The rotor 10 includes a rotor core 11 and magnets 30, which are fixed to the rotor core 11 with plastic.

The rotor core 11 includes an insertion hole 12, magnet housing holes 13, and cooling passages 14. A shaft is inserted into the insertion hole 12. Each magnet housing hole 13 accommodates a magnet 30 together with plastic. Cooling medium that cools the rotor 10 flows through the cooling passages 14.

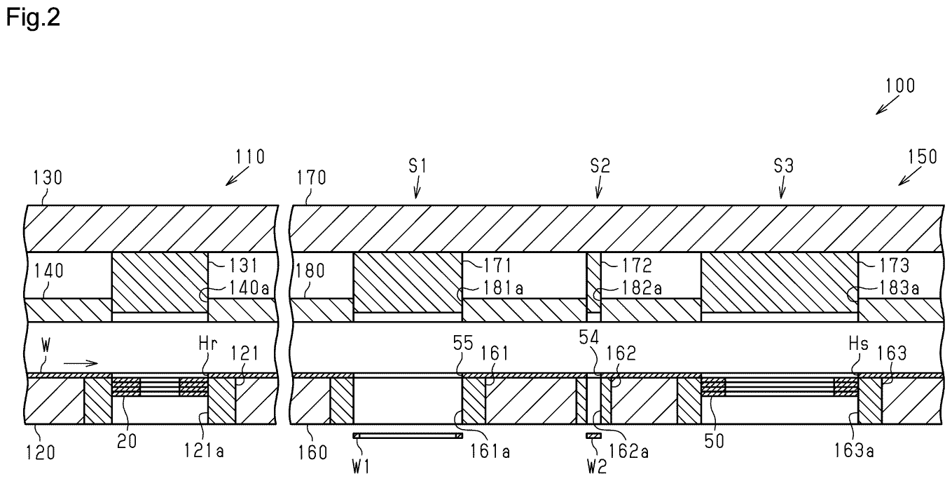

The rotor core 11 is formed by stacking rotor core pieces 20. The rotor core pieces 20 are punched out from a workpiece W such as a magnetic steel sheet (refer to FIG. 2).

### Stator 40

The stator 40 includes a stator core 41 and coils 60 wound around the stator core 41.

The stator core 41 includes a yoke 42, teeth 43, and slots 44. The yoke 42 is annular. The teeth 43 project radially inward from the yoke 42 and are spaced apart from each other in the circumferential direction. The slots 44 are each formed between two of the teeth 43 that are adjacent to each other in the circumferential direction. The slots 44 extend through the stator core 41 in the axial direction.

The stator core 41 includes a center hole 45. The center hole 45 extends through the stator core 41 in the axial direction. The center hole 45 is substantially circular in plan view. Each slot 44 is continuous with the center hole 45.

The stator core 41 includes three fixing portions 46 that protrude outward in the radial direction from the yoke 42. Each fixing portion 46 includes a fixing hole 47, which receives a bolt for fixing the stator core 41 to a housing (not shown). The fixing hole 47 extends in the axial direction through the fixing portion 46.

The stator core 41 is formed by stacking stator core pieces 50. The stator core pieces 50 are punched out from the workpiece W such as a magnetic steel sheet (refer to FIG. 2).

The stator core pieces 50 each include a first through-hole 55, second through-holes 54, and third through-holes 57. The first through-hole 55 is substantially circular. The second through-holes 54 are spaced apart from each other along the outer circumferential edge of the first through-hole 55. The second through-holes 54 are continuous with the first through-hole 55. The third through-holes 57 are located on the radially outer side of the second through-holes 54 to be spaced apart from each other along the outer circumferential edge of the first through-hole 55.

The center hole 45 is formed by connecting multiple first through-holes 55 together in the stacking direction. The slots 44 are formed by connecting multiple second through-holes 54 in the stacking direction. The fixing holes 47 are formed by connecting multiple third through-holes 57 in the stacking direction.

### Pressing Device 100

Next, a pressing device 100 for manufacturing the rotor core 11 and the stator core 41 will be described.

As shown in FIG. 2, the pressing device 100 includes a rotor punching device 110 and a stator punching device 150, which are arranged in series. The stator punching device 150 is an example of an “apparatus for manufacturing a stator core.”

The rotor punching device 110 includes a die device that performs multiple machining processes such as hole punching on the workpiece W, which is intermittently conveyed. The rotor punching device 110 manufactures the rotor core 11 by punching out rotor core pieces 20 from the workpiece W and stacking the rotor core pieces 20.

The stator punching device 150 includes a die device that performs multiple machining processes such as hole punching on the workpiece W, which is intermittently conveyed. The stator punching device 150 manufactures the stator core 41 by punching out stator core pieces 50 from the workpiece W and stacking the stator core pieces 50. The workpiece W, which has been machined by the rotor punching device 110, is conveyed to the stator punching device 150.

### Rotor Punching Device 110

The rotor punching device 110 includes a lower die assembly 120 and an upper die assembly 130, which is configured to approach and move away from the lower die assembly 120. The lower die assembly 120 includes a die 121. A punch 131 is provided in the upper die assembly 130 at a position corresponding to the die 121.

A stripper plate 140 is provided on the upper die assembly 130 to hold the workpiece W when the workpiece W is punched. The stripper plate 140 is urged toward the lower die assembly 120 by an urging member (not shown). The stripper plate 140 includes a punch insertion hole 140a, into which the punch 131 is inserted.

The die 121 includes a die hole 121a, in which the punch 131 moves back and forth. The die hole 121a is substantially circular in correspondence with the outer circumferential shape of the rotor core 11 in plan view.

The rotor punching device 110 punches out the rotor core pieces 20 from the workpiece W through cooperation of the punch 131 and the die 121. The rotor core pieces 20 are held in the die hole 121a and coupled to the subsequently punched out rotor core piece 20. The rotor core 11 is manufactured by sequentially stacking a specified number of rotor core pieces 20 in the die hole 121a and joining the rotor core pieces 20 together.

The rotor punching device 110 is configured to perform, prior to punching out the rotor core pieces 20, machining processes such as hole punching on the workpiece W to form the insertion hole 12, the magnet housing holes 13, and cooling passages 14.

### Stator Punching Device 150

The stator punching device 150 includes a lower die assembly 160 and an upper die assembly 170, which is configured to approach and move away from the lower die assembly 160.

The lower die assembly 160 includes a first die 161, a second die 162, and a third die 163 in that order from the upstream side in the conveying direction of the workpiece W. The upper die assembly 170 includes a first punch 171, second punches 172, and a third punch 173 at positions respectively corresponding to the first die 161, the second die 162, and the third die 163. The first punch 171 and the first die 161 are examples of the “punch” and the “die.”

A stripper plate 180 is provided on the upper die assembly 170 to hold the workpiece W when the workpiece W is punched. The stripper plate 180 is urged toward the lower die assembly 160 by an urging member (not shown). The stripper plate 180 includes a first punch insertion hole 181a, second punch insertion holes 182a, and a third punch insertion hole 183a, into which the first punch 171, the second punches 172, and the third punch 173 are respectively inserted.

The first die 161 includes a first die hole 161a, in which the first punch 171 moves back and forth. The first die hole 161a is substantially circular in correspondence with the shape of the first through-hole 55 in plan view. The first die hole 161a is an example of the “die hole.”

The second die 162 includes second die holes 162a, in which the second punches 172 move back and forth. For illustrative purposes, one of the second punches 172 and one of the second die holes 162a are shown in FIG. 2. In plan view, the second die holes 162a have a substantially rectangular shape corresponding to the shape of the second through-holes 54.

The third die 163 includes a third die hole 163a, in which the third punch 173 moves back and forth. The third die hole 163a is shaped in correspondence with the outer circumferential shape of the stator core 41 in plan view.

The stator punching device 150 includes a first punching station S1, a second punching station S2, and a third punching station S3. The first punching station S1 includes the first die 161 and the first punch 171. The second punching station S2 includes the second die 162 and the second punches 172. The third punching station S3 includes the third die 163 and the third punch 173.

In the stator punching device 150, the workpiece W is conveyed in the order of the first punching station S1, the second punching station S2, and the third punching station S3. Machining stations that perform various machining processes such as forming of tabs on the workpiece W may be provided between the punching stations S1, S2, S3.

The first punching station S1 forms the first through-hole 55 in the workpiece W by punching out a center hole scrap W1 from the workpiece W through cooperation of the first die 161 and the first punch 171.

The second punching station S2 forms the second through-holes 54 in the workpiece W by punching out slot scraps W2 from the workpiece W through cooperation of the second die 162 and the second punches 172. In FIG. 2, the cross-sectional view of the second punching station S2 shows a cross-section different from the cross-sections of the first punching station S1 and the third punching station S3.

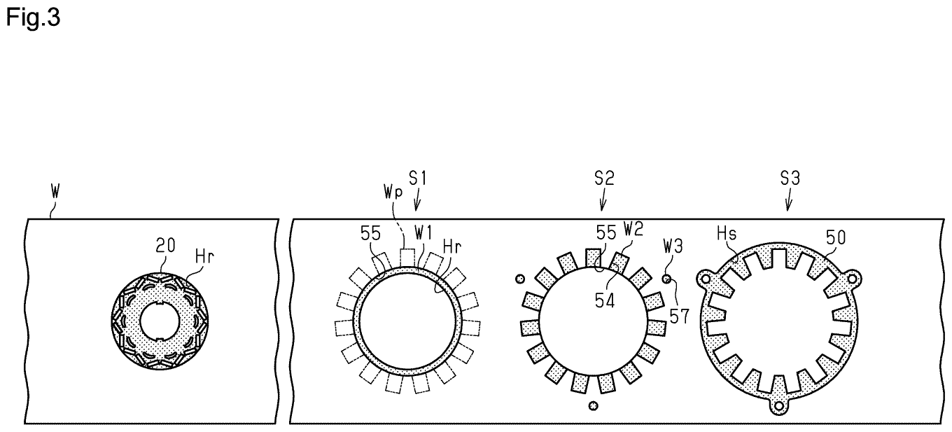

As shown in FIG. 3, the second punching station S2 forms the third through-holes 57 in the workpiece W by punch out the fixing hole scraps W3 from the workpiece W through cooperation of a die and punches (neither is shown). The third through-holes 57 may be formed in the workpiece W at the first punching station S1.

As shown in FIG. 2, the third punching station S3 punches out the stator core pieces 50 from the workpiece W through cooperation of the third die 163 and the third punch 173. The stator core pieces 50 are held in the third die hole 163a and coupled to the subsequently punched out stator core piece 50. The stator core 41 is manufactured by sequentially stacking a specified number of stator core pieces 50 in the third die hole 163a and joining the stator core pieces 50 together.

### Scrap-Rising Suppressing Portion 190

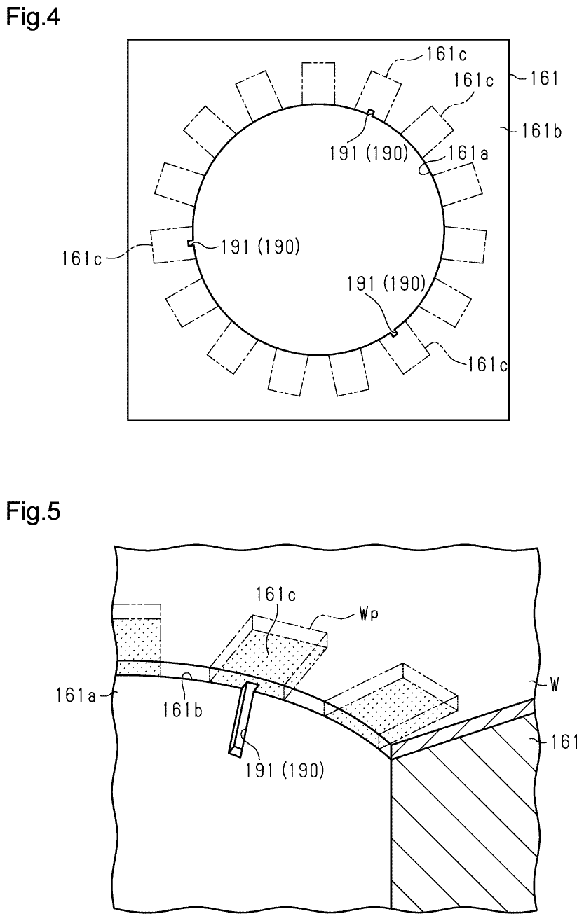

As shown in FIG. 4, scrap-rising suppressing portions 190 are provided on the inner surface of the first die hole 161a and spaced apart from each other in the circumferential direction of the first die hole 161a. When the center hole scrap W1 is punched out from the workpiece W, the scrap-rising suppressing portions 190 plastically deform the center hole scrap W1 by sliding on the center hole scrap W1, thereby increasing a frictional force between the inner surface of the first die hole 161a and the center hole scrap W1.

As shown in FIG. 5, the first die 161 includes a supporting surface 161b, which supports the lower surface of the workpiece W. As indicated by stippling in FIG. 5, the supporting surface 161b includes support portions 161c. The support portions 161c are spaced apart from each other in the circumferential direction of the first die hole 161a. The support portions 161c support the lower surfaces of designated portions Wp, where the second through-holes 54 are to be formed in the workpiece W. Thus, the support portions 161c are located directly below the designated portions Wp.

As shown in FIG. 4, the scrap-rising suppressing portions 190 are provided on the inner surface of the first die hole 161a only on the inner surfaces of the support portions 161c, which are indicated by the long-dash double-short-dash lines. The scrap-rising suppressing portions 190 are provided on the inner surfaces of at least two of the support portions 161c. The scrap-rising suppressing portions 190 of the present embodiment are arranged on the inner surfaces of the three support portions 161c, which are arranged at an interval of 120° in the circumferential direction of the first die hole 161a. In other words, the scrap-rising suppressing portions 190 are provided on the inner surface of the first die hole 161a at equal intervals in the circumferential direction of the first die hole 161a.

As shown in FIG. 5, each scrap-rising suppressing portion 190 includes an inclined groove 191 in the inner surface of the support portion 161c, and inclined with respect to the axial direction of the first die hole 161a. A cross-sectional shape of each inclined groove 191 orthogonal to the longitudinal direction is, for example, quadrangular.

The inclined groove 191 extends from the edge of the first die hole 161a toward the inner side in the axial direction of the first die hole 161a. That is, the inclined groove 191 extends over the cutting edge of the first die hole 161a.

### Method for Manufacturing Rotor Core 11

A method for manufacturing the rotor core 11 will now be described.

The method for manufacturing the rotor core 11 includes several machining steps and a rotor blanking step. In the multiple machining steps, various holes such as the insertion hole 12, the magnet housing holes 13, and the cooling passages 14 are formed in the workpiece W using a progressive die (not shown).

As shown in FIG. 2, in the rotor blanking step, the upper die assembly 130 is first lowered so that the stripper plate 140 presses the workpiece W against the lower die assembly 120. Subsequently, the upper die assembly 130 is further lowered, so that the punch 131 enters the die hole 121a. Accordingly, the punch 131 and the die 121 punch out a rotor core piece 20 from the workpiece W. The workpiece W, from which the rotor core piece 20 has been punched out, includes a rotor through-hole Hr, which corresponds to the shape of the outer circumference of the rotor core piece 20.

In the die hole 121a, multiple rotor core pieces 20 are stacked and joined together. The rotor core 11 is manufactured by stacking a specified number of rotor core pieces 20 in the die hole 121a.

### Method for Manufacturing Stator Core 41

A method for manufacturing the stator core 41 will now be described.

The method for manufacturing the stator core 41 includes a first punching step, a

second punching step, and a third punching step. The method for manufacturing the stator core 41 may include various machining steps for, for example, punching holes or forming tabs in the workpiece W.

Prior to the first punching step, a portion of the workpiece W in which the rotor through-hole Hr is formed is conveyed to the first punching station S1 by a feed device (not shown).

In the first punching step, first, the upper die assembly 170 is lowered, so that the stripper plate 180 presses the workpiece W against the lower die assembly 160. Subsequently, the upper die assembly 170 is further lowered, so that the first punch 171 enters the first die hole 161a. Accordingly, the first punch 171 and the first die 161 punch out a center hole scrap W1 from the workpiece W. The workpiece W, from which the center hole scrap W1 has been punched out, has a first through-hole 55.

In the first punching step, a part of the workpiece W radially outward of the rotor through-hole Hr is punched out from the workpiece W as the center hole scrap W1 to form the first through-hole 55. The center hole scrap W1 is a part radially outward of the rotor through-hole H and is punched out to be coaxial with the rotor through-hole Hr. The center hole scrap W1 thus has an annular shape.

The first punching step includes a deformation process that plastically deforms the center hole scrap W1 by sliding the center hole scrap W1 on the scrap-rising suppressing portions 190, thereby increasing a frictional force between the inner surface of the first die hole 161a and the center hole scrap W1. The deformation process is performed on only the inner surfaces of some support portions 161c, which are parts of the inner surface of the first die hole 161a. Specifically, the deformation process is performed only on the inner surfaces of some of the support portions 161c that include the scrap-rising suppressing portions 190.

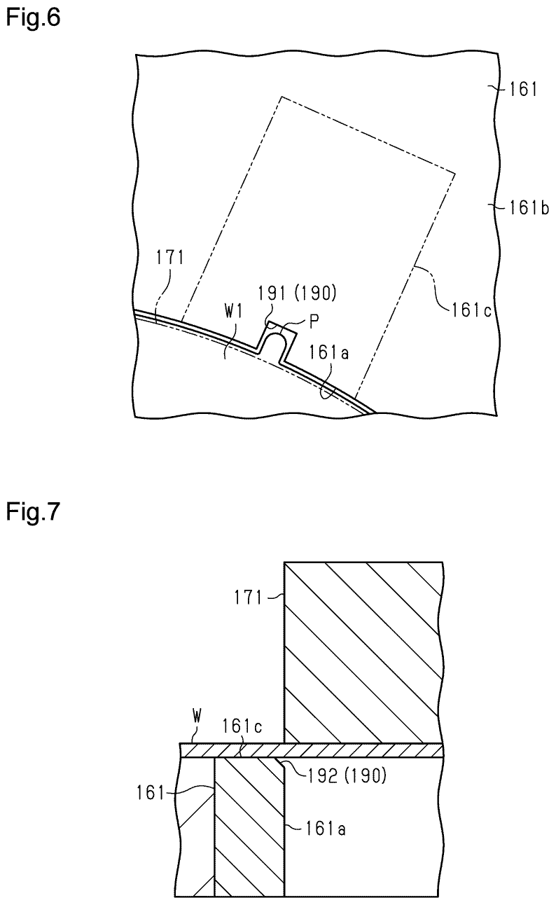

As shown in FIG. 6, in each part of the inner surface of the first die hole 161a where an inclined groove 191 is formed, the clearance between the outer surface of the first punch 171 and the inner surface of the first die hole 161a is larger than in other parts. Therefore, at the beginning of the punching-out of the center hole scrap W1, protrusions P, which protrude into the inclined grooves 191, are formed on portions of the center hole scrap W1 that face the inclined grooves 191. In this state, when the center hole scrap W1 is pushed in the axial direction into the first die hole 161a by the first punch 171, each protrusion P moves over the corresponding inclined groove 191 while being crushed on the wall surface of the inclined groove 191. This allows the protrusion P to reach the part of the inner surface of the first die hole 161a at which the inclined grooves 191 are not formed. At this time, the protrusions P are strongly pressed against the inner surface of the first die hole 161a and thus increases the frictional force between the inner surface of the first die hole 161a and the center hole scrap W1. As a result, the center hole scrap W1 is held in the first die hole 161a.

Although not illustrated, as the protrusions P are formed on the center hole scrap W1, deformation marks corresponding to the protrusions P are formed in parts of the edge of the first through-hole 55 that correspond to the protrusions P.

Next, prior to the second punching step, when the stripper plate 180 and the first punch 171 are separated from the workpiece W as the upper die assembly 170 is lifted as shown in FIG. 2, the part of the workpiece W in which the first through-hole 55 is formed is conveyed to the second punching station S2.

In the second punching step, first, the upper die assembly 170 is lowered, so that the stripper plate 180 presses the workpiece W against the lower die assembly 160. Subsequently, the upper die assembly 170 is further lowered, so that the second punches 172 enter the second die holes 162a. Accordingly, the second punches 172 and the second die 162 punch out the slot scraps W2 from the workpiece W. The workpiece W, from which the slot scraps W2 have been punched out, includes second through-holes 54 continuous with the first through-hole 55.

Further, in the second punching step, the fixing hole scraps W3 are punched out by punches and a die (neither is shown) to form the third through-holes 57 in the workpiece W.

Next, prior to the third punching step, when the stripper plate 180 and the second punch 172 are separated from the workpiece W as the upper die assembly 170 is lifted, the part of the workpiece W in which the first through-hole 55 is formed is conveyed to the third punching station S3.

In the third punching step, first, the upper die assembly 170 is lowered, so that the stripper plate 180 presses the workpiece W against the lower die assembly 160. Subsequently, the upper die assembly 170 is further lowered, so that the third punch 173 enters the third die hole 163a. Accordingly, the third punch 173 and the third die 163 punch out a stator core piece 50 from the workpiece W. The workpiece W, from which the stator core piece 50 has been punched out, includes a stator through-hole Hs, which corresponds to the shape of the outer circumference of the stator core piece 50.

In the third die hole 163a, multiple stator core pieces 50 are stacked and joined together. The stator core 41 is manufactured by stacking a specified number of stator core pieces 50 in the third die hole 163a.

Operation and advantages of the present embodiment will now be described.

(1) In the first punching step, the center hole scrap W1 is punched out from the workpiece W to form the first through-hole 55. In the second punching step, the slot scraps W2 are punched out from the workpiece W, in which the first through-hole 55 is formed, to form the second through-holes 54. The first punching step includes the deformation process that plastically deforms the center hole scrap W1 by sliding the center hole scrap W1 on the scrap-rising suppressing portions 190, which are provided on the inner surface of the first die hole 161a, thereby increasing the frictional force between the inner surface of the first die hole 161a and the center hole scrap W1. The deformation process is performed on only the inner surfaces of the support portions 161c.

With the above-described method, after the center hole scrap W1 is punched out from the workpiece W in the first punching process, the multiple slot scraps W2 are punched out from the workpiece W in the second punching process. That is, at the point in time when the center hole scrap W1 is punched out from the workpiece W, the slot scraps W2 have not been punched out from the workpiece W. Accordingly, the area of contact between the inner surface of the first die hole 161a and the center hole scrap W1 is increased as compared to a case in which the center hole scrap W1 is punched out after the slot scraps W2 are punched out from the workpiece W. In addition, in the first punching step, the deformation process is performed to plastically deform the center hole scrap W1 by sliding the center hole scrap W1 on the scrap-rising suppressing portions 190. This increases the frictional force generated between the inner surface of the first die hole 161a and the center hole scrap W1. This suppresses the rising of the center hole scrap W1.

Further, the scrap-rising suppressing portions 190 are provided on the inner surface of the first die hole 161a. Thus, deformation marks corresponding to the plastic deformation of the center hole scrap W1 are formed in parts of the edge of the first through-hole 55 that correspond to the scrap-rising suppressing portions 190. Such deformation marks formed on the stator core piece 50 may lower the product accuracy of the stator core 41.

In this regard, in the above-described method, the deformation process is performed only on the inner surfaces of the support portions 161c that are parts of the inner surface of the first die hole 161a, and the support portions 161c are parts of the first die 161 that support the portions of the workpiece W in which the second through-holes 54 are to be formed. Thus, the deformation marks formed on the edge of the first through-hole 55 are punched out together with the slot scraps W2 when the second through-holes 54 are formed in the workpiece W. This prevents deformation marks from being formed on the edge of the first through-hole 55. This suppresses a decrease in the product accuracy of the stator core 41.

(2) The first punching step uses, as the first die 161, a die in which the scrap-rising suppressing portions 190 are formed by the inclined grooves 191.

In the above-described method, the protrusions P are formed on parts of the center hole scrap W1 that face the inclined grooves 191. When the center hole scrap W1 is pushed into the first die hole 161a, the protrusions P are crushed on the wall surfaces of the inclined grooves 191 and then strongly pressed against the wall surface of the first die hole 161a. This holds the protrusions P in the first die hole 161a and thus suppresses rising of the center hole scrap W1. Rising of the center hole scrap W1 is thus suppressed by a simple method.

(3) The first punching step uses, as the first die 161, a die in which the scrap-rising suppressing portions 190 are provided on the inner surfaces of at least two of the support portions 161c.

With the above-described method, at least two scrap-rising suppressing portions 190 are provided on the inner surface of the first die hole 161, while being spaced apart from each other. Thus, plastic deformation occurs through the deformation process at least at two positions of the center hole scrap W1. This increases the frictional force generated between the inner surface of the first die hole 161a and the center hole scrap W1. This suppresses the rising of the center hole scrap W1.

(4) In the first punching step, the part of the workpiece W, on the radially outward of the part from which the rotor core piece 20 has been punched out, is punched out as the center hole scrap W1 to form the first through-hole 55.

With the above-described method, the part of the workpiece W, on the radially outward of the part from which the rotor core piece 20 has been punched out, is punched out as the center hole scrap W1. This allows the stator iron core piece 50 to be punched out from a part of a single workpiece W on a radially outer side of the rotor core piece 20. This allows parts of the workpiece W that would be scrap to be effectively used in manufacturing the stator core 41.

(5) The stator punching device 150 includes the first punching station S1, which forms the first through-hole 55 in the workpiece W, and the second punching station S2, which forms the second through-holes 54 in the workpiece W. The scrap-rising suppressing portions 190 are provided on the inner surface of the first die hole 161a in the first punching station S1. The scrap-rising suppressing portions 190 are provided only on the inner surfaces of the support portions 161c.

This configuration has an operation and advantages similar to the above-described operation and advantage (1).

### Modifications

The above-described embodiment may be modified as follows. The above-described embodiment and the following modifications can be combined as long as the combined modifications remain technically consistent with each other.

In the first punching step, the first through-hole 55 may be formed by punching out the center hole scrap W1 from the workpiece W in which the rotor through-hole Hr is not formed. In this case, the center hole scrap W1 is circular.

A single scrap-rising suppressing portion 190 may be provided on the inner surface of the first die hole 161a. Alternatively, multiple scrap-rising suppressing portions 190 may be provided on the inner surface of the first die hole 161a. The scrap-rising suppressing portions 190 may be arranged at irregular intervals in the circumferential direction of the first die hole 161a.

The cross-sectional shape of each inclined groove 191 orthogonal to the longitudinal direction is not limited to quadrangular and may be, for example, semicircular.

As shown in FIG. 7, the scrap-rising suppressing portion 190 may include an inclined surface 192 formed on a part of the inner surface of the support portion 161c that defines the edge of the first die hole 161a. With this configuration, in a portion of the center hole scrap W1 that is in contact with the inclined surface 192, the amount of roll-over in the center hole scrap W1 is likely to be greater than other portions. Thus, when the roll-over of the center hole scrap W1 is strongly pressed against the inner surface of the first die hole 161a, the center hole scrap W1 is readily held by the inner surface of the first die hole 161ak. Rising of the center hole scrap W1 is thus suppressed by a simple method.

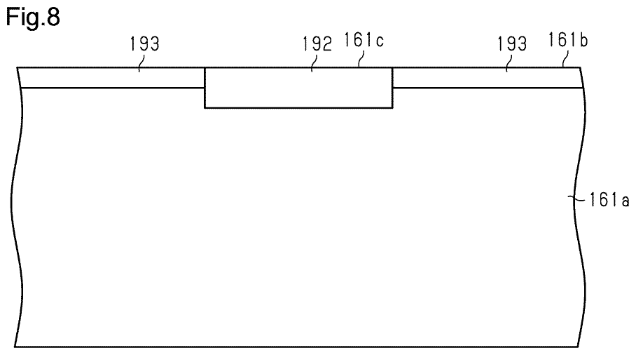

As shown in FIG. 8, the edge of the first die hole 161a may include inclined surfaces 192 and inclined surfaces 193, which have different shapes and adjacent to each other in the circumferential direction of the first die hole 161a. Each inclined surface 192 is the same as that in the above-described modification. The inclined surfaces 193 are each formed on a part of the inner surface of the first die 161 that is adjacent to a support portion 161c in the circumferential direction. The distance between the upper edge and the lower edge of each inclined surface 193 is less than the distance between the upper edge and the lower edge of each inclined surface 192. The inclination angle of each inclined surface 192 with respect to the supporting surface 161b may be the same or different from the inclination angle of each inclined surface 193 with respect to the supporting surface 161b. With this configuration, roll-over is likely to form in portions of the center hole scrap W1 that are in contact with the inclined surfaces 192 and the inclined surfaces 193. As a result, the center hole scrap W1 is readily held by the inner surface of the first die hole 161a. Also, the distance between the upper edge and the lower edge of each inclined surface 193 is less than the distance between the upper edge and the lower edge of each inclined surface 192. Therefore, the roll-over of the center hole scrap W1 caused by contact with the inclined surfaces 193 is smaller than the roll-over caused by contact with the inclined surfaces 192. This reduces the deformation marks corresponding to the roll-over of the center hole scrap W1 on the edge of the first through-hole 55 formed in the stator iron core piece 50. This suppresses rising of the center hole scrap W1, while limiting a decrease in the product accuracy of the stator core 41.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a stator core, the stator core including a center hole and multiple slots, the slots being continuous with the center hole and spaced apart from each other in a circumferential direction of the center hole, and the stator core being formed by stacking multiple core pieces punched out from a workpiece, the method comprising:
punching out a center hole scrap from the workpiece through cooperation of a punch and a die that includes a die hole in which the punch moves back and forth, thereby forming a first through-hole that forms the center hole; and
punching out multiple slot scraps from the workpiece in which the first through-hole has been formed, thereby forming multiple second through-holes that respectively form the multiple slots, wherein
the punching out the center hole scrap from the workpiece includes a deformation process that plastically deforms the center hole scrap by sliding the center hole scrap on a scrap-rising suppressing portion provided on an inner surface of the die hole, thereby increasing a frictional force between the inner surface of the die hole and the center hole scrap, and
the deformation process is performed only on at least one of inner surfaces of support portions, the inner surfaces of the support portions being parts of the inner surface of the die hole, and the support portions being parts of the die that support portions of the workpiece in which the second through-holes are to be formed.

2. The method for manufacturing the stator core according to claim 1, further comprising using, as the die, a die in which the scrap-rising suppressing portion is formed by an inclined groove in the inner surface of the support portion, the inclined groove extending so as to be inclined with respect to an axial direction of the die hole.

3. The method for manufacturing the stator core according to claim 1, further comprising using, as the die, a die in which the scrap-rising suppressing portion is formed by an inclined surface formed in a portion of the inner surface of the support portion that forms an edge of the die hole.

4. The method for manufacturing the stator core according to claim 1, further comprising using, as the die, a die in which the scrap-rising suppressing portion is provided on each of the inner surfaces of at least two of the support portions that are spaced apart in a circumferential direction of the die hole.

5. The method for manufacturing a stator core according to claim 1, further comprising using, as the workpiece, a workpiece from which a rotor core piece has been punched out, the rotor core piece forming a rotor core that is disposed inside the center hole,
wherein the punching out the center hole scrap from the workpiece includes forming the first through-hole by punching out, as the center hole scrap, a part of the workpiece radially outward of a part from which the rotor core piece has been punched out.

6. An apparatus for manufacturing a stator core, the stator core including a center hole and multiple slots, the slots being continuous with the center hole and spaced apart from each other in a circumferential direction of the center hole, and the stator core being formed by stacking multiple core pieces punched out from a workpiece, the apparatus comprising:
a first punching station that includes a punch and a die that includes a die hole in which the punch moves back and forth, the first punch-out station being configured to punch out a center hole scrap from the workpiece through cooperation of the punch and the die, thereby forming a first through-hole that forms the center hole; and
a second punching station that is configured to punch out multiple slot scraps from the workpiece in which the first through-hole has been formed, thereby forming multiple second through-holes that respectively form the multiple slots, wherein
a scrap-rising suppressing portion is provided on an inner surface of the die hole, the scrap-rising suppressing portion plastically deforming the center hole scrap by sliding the center hole scrap on the scrap-rising suppressing portion, thereby increasing a frictional force between the inner surface of the die hole and the center hole scrap,
the die includes support portions that are configured to support portions of the workpiece in which the second through-holes are to be formed, the support portions each having an inner surface that is a part of the inner surface of the die hole, and
the scrap-rising suppressing portion is provided only on the inner surface of at least one of the support portions.
